(19) United States
(12) Patent Application Publication
(10) Pub. No.: US 2008/0085742 A1
(43) Pub. Date: Apr. 10, 2008

(54) MOBILE COMMUNICATION TERMINAL

(76) Inventors: Minna Karukka, Oulu (FI); Johanna Sakkinen, Oulu (FI); Petri Kangas, Oulu (FI); Mika P. Mustonen, Ii (FI); Peter Dam Nielsen, Lyngby (DK); Christian Kraft, Frederiksberg (DK)

Correspondence Address: PERMAN & GREEN, 425 POST ROAD, FAIRFIELD, CT, 06824, US

(21) Appl. No.: 11/548,122

(22) Filed: Oct. 10, 2006

(51) Int. Cl. G10L 15/04; H04B 1/38

(52) U.S. Cl. 455/569.1; 704/251; 704/270.1

(57) ABSTRACT

A method for recording audio using a mobile communication terminal while a microphone connected to the mobile communication terminal provides audio data for an audio communication channel to a remote party. The method includes detecting a first user input indicating a private recording is to be started; stopping provision of audio data from the microphone to the audio communication channel; receiving an audio signal from the microphone; and recording the audio signal.

Various methods of storing keywords are also presented.

### FIELD

The disclosed embodiments generally relate to mobile terminals and more particularly to data management using mobile terminals.

### BACKGROUND

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image, audio or video recording, FM radio, music playback, electronic games, calendar/organizer/time planner, word processing, etc. Furthermore, the modern terminals have local connectivity abilities, such as Bluetooth, allowing the mobile terminals to communicate with a wide array of devices.

With the capabilities of modern mobile terminals, it is possible to record sound clips, using the microphone normally used during phone calls, and storing these sound clips for later use. However it is a problem that sound clips can not easily be recorded while the user is engaged in a phone call. One way to solve this is to allow the user to record the phone call in its entirety or parts thereof. However, there still remain drawbacks with flexibility of such functionality.

Also, there is a problem with keeping track of previous phone calls. It is previously known to keep a list of previously received and/or placed calls, where each entry has information about time, remote party, etc. However, if is still a problem for the user to know more details about each phone call, e.g. what was discussed.

Also, there is a problem with keeping track of contact records. contact records here relate to records of information stored in the mobile terminal regarding name, phone numbers, email addresses, etc. Users of mobile terminals store more and more contact records. This increases the difficulty of keeping track of who is who, which is made even more difficult if the user only stores contact names using first names.

Consequently, there is a need for an improved mobile communication terminal addressing the problems discussed above.

### SUMMARY

In view of the above, an objective of the invention is to solve or at least reduce the problems discussed above.

Generally, the above objectives are achieved by the attached independent patent claims.

A first expression of a inventive aspect is a method for recording audio using a mobile communication terminal while a microphone connected to the mobile communication terminal provides audio data for an audio communication channel to a remote party, the method comprising: detecting a first user input indicating a private recording is to be started; stopping provision of audio data from the microphone to the audio communication channel; receiving an audio signal from the microphone; and recording the audio signal.

This allows a user to privately record audio from the microphone without the remote user hearing this. In other words, it allows the user to take private notes without bothering remote users.

The method may further comprise: detecting a second user input indicating the private recording is to be paused; pausing the recording of the audio signal; and reestablishing the provision of audio data from the microphone to the audio communication channel.

The detecting a first user input may involve detecting a first actuation of a user interface element and the detecting a second user input may involve detecting a second actuation of the user interface element.

The detecting a first user input may involve detecting a depression of a user interface element and the detecting a second user input may involve detecting a release of the user interface element.

The method may further comprise: detecting a third user input indicating the private recording is to be stopped; stopping the recording of the audio signal; and storing the recording of the audio signal in persistent memory.

A second expression of the first inventive aspect is a mobile communication terminal for recording audio while a microphone connected to the mobile communication terminal provides audio data for an audio communication channel to a remote party, the mobile communication terminal comprising a controller, wherein: the controller is configured to detect a first user input indicating a private recording is to be started; the controller is further configured to, as a response to the first user input, stop the provision of audio data from the microphone to the audio communication channel; the controller is further configured to receive an audio signal from a microphone; and the controller is further configured to, as a second response to the first user input, record the audio signal.

A third expression of the first inventive aspect is a computer program product comprising software instructions that, when executed in a mobile communication terminal, performs the method according to the first expression of the first inventive aspect.

A first expression of a second inventive aspect is a method for storing keywords using a mobile communication terminal while a user of the mobile communication terminal is in audio communication over a communication channel with a remote party, the method comprising: acquiring audio data related to the communication channel converting at least part of the audio data to text data; determining if the text data contains a keyword; if it is determined that the text data contains a keyword, storing the keyword associated with information regarding the remote party.

This allows the user to automatically have keywords associated with each call, alleviating remembering what was said in each call.

The determining if the text data may contain a keyword may involve comparing a candidate word of the text data against a list of words, the candidate word being determined to be a keyword if the candidate word is excluded in the list.

The list of words may be a list of words used for predictive text functionality used when entering text in the mobile communication terminal.

The determining if the text data contains a keyword may involve comparing a candidate word of the text data against a list of words, the candidate word being determined to be a keyword if the candidate word is included in the list.

The determining if the text data contains a keyword may involve counting the number of letters of a candidate word of the text data, the candidate word being determined to be a keyword if the number of letters is greater than a threshold number of letters.

The storing the keyword may involve storing the keyword, the keyword being associated with a contact record of the mobile communication terminal related to the remote party.

The method may further comprise, before the storing the keyword: if it is determined that the text data contains a keyword, displaying the keyword to the user.

The method may further comprise, before the storing the keyword: if it is determined that the text data contains a keyword, allowing the user to edit the keyword.

The converting audio data, determining if the text data contains a keyword, and if it is determined that the text data contains a keyword, storing the keyword, may be repeated until the audio communication ends.

The method may further comprise, after the audio communication ends: displaying all keywords determined during the audio communication.

The method may further comprise, after the displaying all keywords: enabling removal any of the displayed keywords.

The method may further comprise, after the displaying all keywords: enabling addition of user entered keywords to the displayed keywords.

A second expression of the second inventive aspect is a mobile communication terminal for storing keywords using a mobile communication terminal while a user of the mobile communication terminal is in audio communication over a communication channel with a remote party, the mobile communication terminal comprising a controller and memory, wherein: the controller is configured to acquire audio data related to the communication channel, the controller is configured to convert at least part of the audio data to text data; the controller is configured to determine if the text data contains a keyword; the controller is configured to, if it is determined that the text data contains a keyword, store the keyword in the memory, associated with information regarding the remote party.

A third expression of the second inventive aspect is a computer program product comprising software instructions that, when executed in a mobile communication terminal, performs the method according to the first expression of the second inventive aspect.

A first expression of the third inventive aspect is a method for managing contact data in a mobile communication terminal, where keywords are associated with a contact record stored by the mobile communication terminal, the method comprising: acquiring a keyword from text data related to communication with a party identified by the contact record; storing the keyword with an association to the contact record.

This automatically provides the user with key words for each contact, allowing the user to easier remember what person each contact record is associated with.

The acquiring a keyword may involve acquiring a keyword from text data in a text message communication with a party identified by the contact record.

The acquiring a keyword may involve acquiring a keyword from text data in a instant messaging communication with a party identified by the contact record.

The acquiring a keyword may involve converting at least part of audio data from voice communication with a party identified by the contact record to text data and acquiring a keyword from the text data.

The method may further comprise: when displaying a contact record, displaying at least part of keywords stored and associated with the contact record.

The method may further comprise: when displaying a list of contact records, displaying at least part of keywords stored and associated with each displayed contact record.

The displaying a list of contact records may involve: when displaying a list of contact records, displaying at least part of keywords stored and associated with each contact record, and for a highlighted contact record, scrolling through all keywords stored and associated with the highlighted contact record on one row.

The acquiring a keyword from text data may involve comparing a candidate word of the text data against a list of words, the candidate word being determined to be a keyword if the candidate word is excluded in the list.

The list of words may be a list of words used for predictive text functionality used when entering text in the mobile communication terminal.

The acquiring a keyword from text data may involve comparing a candidate word of the text data against a list of words, the candidate word being determined to be a keyword if the candidate word is included in the list.

The acquiring a keyword from text data may involve counting the number of letters of a candidate word of the text data, the candidate word being determined to be a keyword if the number of letters is greater than a threshold number of letters.

A second expression of the third inventive aspect is a mobile communication terminal for managing contact data, where keywords are associated with a contact record stored by said mobile communication terminal, said mobile communication terminal comprising a controller and memory, wherein:

said controller is configured to acquire a keyword from text data related to communication with a party identified by said contact record;

said controller is configured to store said keyword with an association to said contact record.

A third expression of the third inventive aspect is a computer program product comprising software instructions that, when executed in a mobile communication terminal, performs the method according to the first expression of the third inventive aspect.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects of the disclosed embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile terminal according to an aspect of the disclosed embodiments.

FIG. 3 is a schematic block diagram representing an internal component, software and protocol structure of the mobile terminal shown in FIG. 2.

FIG. 4 is a flowchart diagram illustrating the execution of the mobile terminal shown in FIG. 2 to record private sound clips.

FIG. 5 is a flowchart diagram illustrating the execution of the mobile terminal shown in FIG. 2 to store keywords for a phone call.

FIG. 6 shows a screen displaying previous calls with keywords found according to the process described in conjunction with FIG. 5.

FIG. 7a is a flowchart diagram illustrating the execution of the mobile terminal shown in FIG. 2 to store keywords for a contact.

FIG. 7b is a flowchart diagram illustrating the execution of the mobile terminal shown in FIG. 2 to view keywords for a contact.

FIG. 8 shows a view of three displays illustrating the process described in conjunction with FIG. 7b.

### DETAILED DESCRIPTION

The disclosed embodiments will now be described more fully hereinafter with reference to the accompanying drawings, in which certain embodiments are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

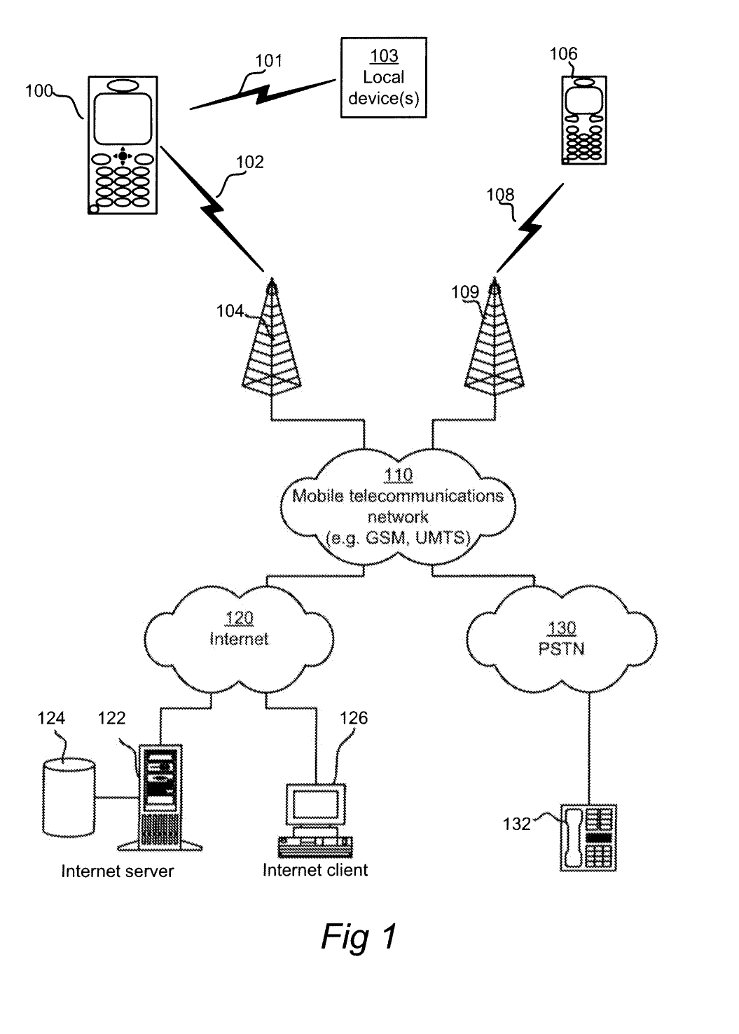

FIG. 1 illustrates an example of a cellular telecommunications system in which the disclosed embodiments may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the disclosed embodiments and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be microphones, headsets, GPS receivers etc.

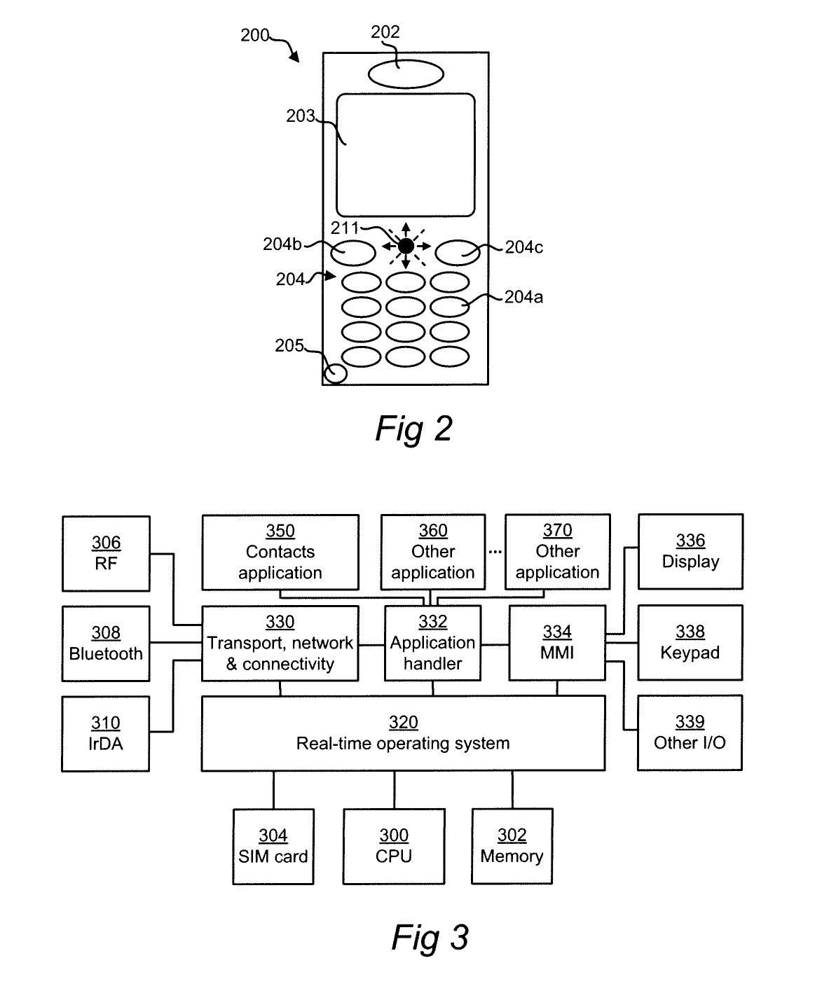

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, hard drive, optic memory or any combination thereof. The memory 302 is used for various purposes by the controller 300, one of them being for storing data and program instructions for various software in the mobile terminal. The memory 302 can be internal to the mobile terminal or an external memory connected to the mobile terminal. The software includes a real-time operating system 320, drivers for a man-machine interface (MMI) 334, an application handler 332 as well as various applications. The applications can include a contacts application 350, as well as various other applications 360 and 370, such as applications for voice calling, video calling, sending and receiving SMS, MMS or email, voice clip recording, web browsing, an instant messaging application, a calendar application, a control panel application, a camera application, a media player, one or more video games, a notepad application, etc.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

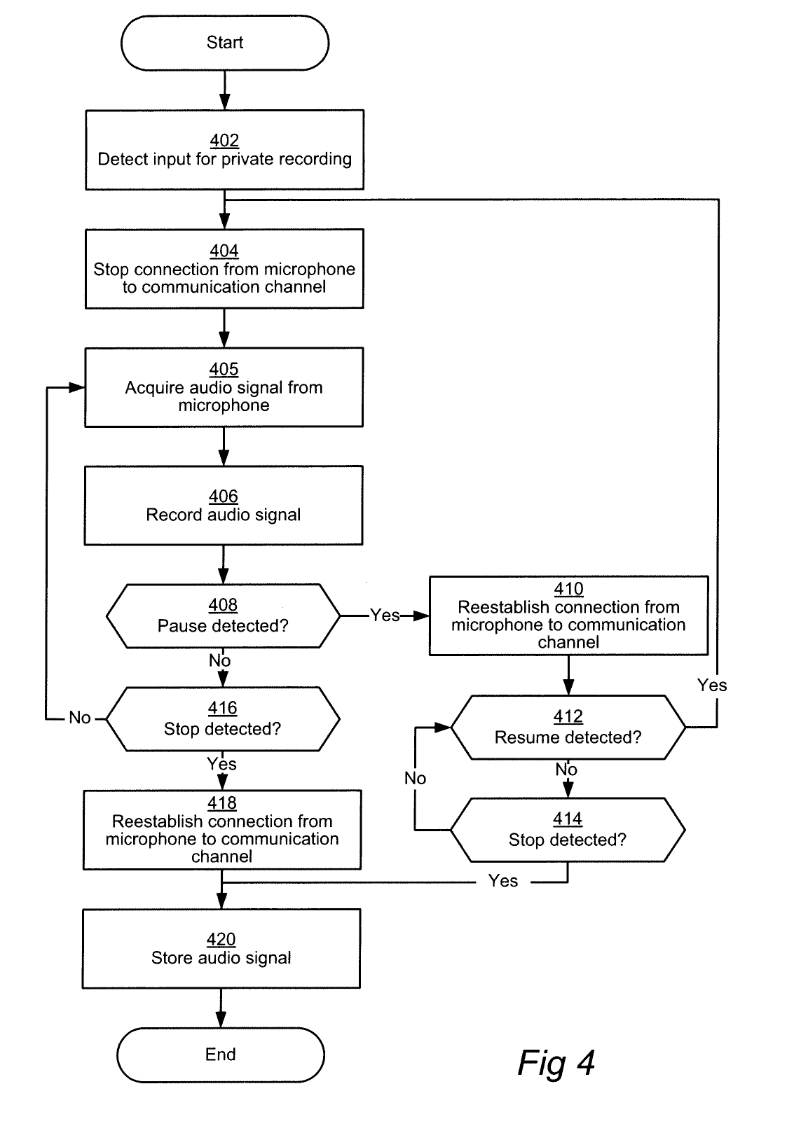

FIG. 4 is a flowchart diagram illustrating the execution of the mobile terminal 200 shown in FIG. 2 to record private audio clips. When this process begins, a voice communication channel has been set up between a local mobile terminal 100 (FIG. 1) and a remote mobile terminal 106 (FIG. 1).

In a detect input for private recording step 402, a user input is detected indicating that the user desires to start a private recording. The user input can be any type of suitable user input known in the art, including a dedicated key for audio recording, a soft key, a voice command, etc.

In a stop connection from microphone to communication channel step 404, the connection between the microphone (internal or external) of the mobile terminal 100 and the communication channel is stopped. In other words, any audio caught by the microphone will no longer be transmitted over the communication channel to the remote mobile terminal 106. In this embodiment, the audio detected by the remote mobile terminal 106 will still be transmitted over the communication channel to the local mobile terminal 100, but it is equally possible to stop the communication from remote mobile terminal 106 to local mobile terminal 100 during the private recording.

In an acquire audio signal from microphone step 405, the audio signal is received by the microphone is received. Also, in this step, any suitable processing known in the art is performed, such as analog-to-digital conversion, sound filtering, etc.

In a record audio signal step 406, the processed audio signal from the previous step is recorded. The signal could be recorded in volatile memory, such as RAM, or permanent memory, such as flash memory.

In a conditional pause detected step 408 it is determined whether a user input representing a pause is detected. This user input can be an actuation of a soft key, a dedicated key, a voice command, etc. In one embodiment, a desire by the user to pause is detected by a release of the key that was used to initiate the private recording. If a pause is detected, the process proceeds to a reestablish connection from microphone to communication channel step 410. If, on the other hand, a pause is not detected, the process proceeds to a conditional stop detected step 416.

In the reestablish connection from microphone to communication channel step 410, the connection between the microphone and the communication channel used for audio communication is reestablished. In other words, any audio detected by the microphone will hereafter be transmitted on the communication channel to the remote mobile terminal 106.

In the conditional resume detected step 412, it is determined whether a user input representing a resume is detected. If a resume is detected, the process returns to the stop communication from microphone to communication channel step 404. If, on the other hand, a resume is not detected, the process proceeds to a conditional stop detected step 414.

In the conditional stop detected step 414, it is determined whether a user input representing a stop is detected. If a stop is detected, the process proceeds to a store audio signal step 420. If, on the other hand, a stop is not detected, the process returns to the conditional resume detected step 412.

In a reestablish connection from microphone to communication channel step 418, the connection between the microphone and the communication channel used for audio communication is reestablished. In other words, any audio detected by the microphone will hereafter be transmitted on the communication channel to the remote mobile terminal 106.

In the store audio signal step 420 the audio signal recorded in the record audio signal step 406 is stored in persistent memory.

It is to be noted that the effect of the process shown in FIG. 4 can alternatively be achieved using two or more separate multi-tasked processes, as is known in the art, where one of these tasks is responsible for receiving user input events and communicating these events to other tasks.

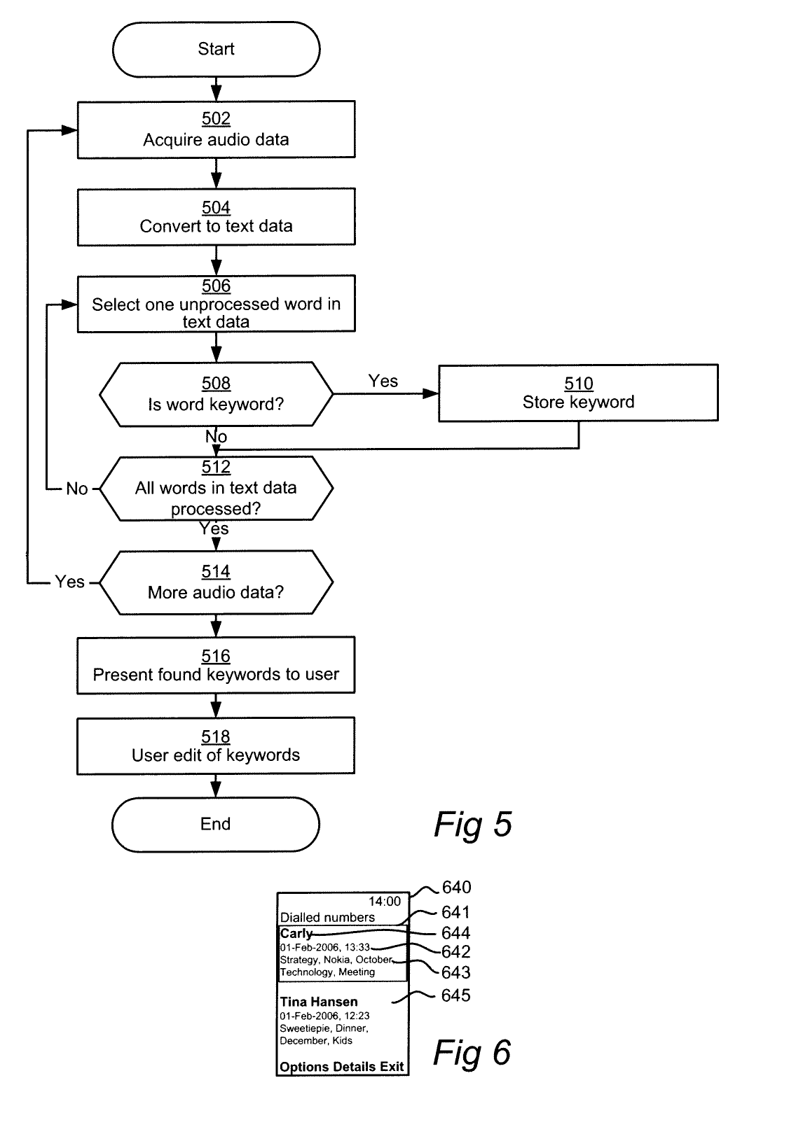

FIG. 5 is a flowchart diagram illustrating the execution of the mobile terminal 200 shown in FIG. 2 to store keywords for a phone call. When this process begins, a communication channel for voice communication has just been set up as a call between a local mobile terminal 100 (FIG. 1) and a remote mobile terminal 106 (FIG. 1). Optionally, this processing can be made user configurable, such that it will not be performed if the user has indicated it should not.

In an acquire audio data step 502, audio data is acquired from the communication channel. The audio data can relate to either outgoing communication or incoming communication or both. In one embodiment, what communication is to be considered is user configurable. The audio data is captured when it is represented as digital data (or converted from analog to digital data), and optional filtering is applied. Typically, the audio data is temporarily stored in chunks for this process to process, allowing the voice call to proceed in one task (in a multitasking environment) in the mobile terminal 100 while still providing all the desired audio data to this process. This process then processes one chunk of audio data at a time, until there is no more audio data.

In a convert to text data step 504, the audio data is converted to text data using a speech-to-text algorithm. The algorithm does not need to be perfect, it is sufficient if a substantial portion of the audio data is converted to text data. This will be discussed in more detail below. The output from this step is one or more words in text format.

In a select one unprocessed word in text data step 506, one of the words in the extracted text data is selected for processing.

In the conditional is word keyword step 50S, it is determined if the word being processed, or candidate word, is a keyword. There are several ways that this can be done, which will now be explained.

One way to determine a keyword is to check the word length of the candidate word. If the number of letters exceeds a certain number, the candidate word is considered to be a keyword. This will exclude most common words which are less unique and therefore less descriptive.

Another way to determine a keyword is to check if the candidate word is in a list of words which are considered less common and therefore are good keywords. Thus, if there is a match between the candidate word and a word in the list of less common words, the candidate word is considered a keyword. Optionally, the list of less common words is user configurable.

Yet another way to determine a keyword is to check if the candidate word is not in a list of words which are considered common. The candidate word is thus likely to be less common and therefore more unique if it is not in the list of common words. Such a list of common words can for example be a list of words used for predictive text entry, such as T9. Optionally, the user can edit this list of common words.

Additionally, in one embodiment, the candidate word can be checked against a list of keywords determined prior to the current call, where the candidate word is not considered a keyword if it has been determined to be a keyword previously, either in calls to the same remote mobile terminal, or all previous calls.

If the candidate word is considered a keyword, the process proceeds to a store keyword step 510. If, on the other hand, the word is not determined to be a keyword, the process proceeds to a conditional all words in text data processed step 512.

In the store keyword step 510, the keyword is stored, associated with the call in progress. The keyword may be stored directly in persistent memory or it may be stored in volatile memory initially, for later storage in persistent memory.

In the conditional all words in text data processed step 512, it is determined if all the words in the text data has been processed. If this is the case, the process proceeds to a conditional more audio data step 514. If, on the other hand, there are more words to be processed, the process returns to the select one unprocessed word in text data step 506.

In the conditional more audio data step 514, it is determined if there is more audio data to process. If this is the case, the process returns to the acquire audio data step 502. If, on the other hand, there is no more audio data to process, the process proceeds to a present found keywords to user step 516.

In the present found keywords to user step 516, the call has now ended and the user is presented with all keywords that have been found for the call that just ended.

In the user edit of keywords step 518, the user can edit the keywords that are presented. The user can add, remove and edit keywords, before accepting the list. When the list is accepted, the keywords are stored in persistent memory, associated with the call in question and this process ends.

This process allows the user to browse previous calls and see keywords associated with each call. Consequently, the user is given hints to what the conversation was about.

One advantage with the process described above is that it works even if a recognition ratio of the voice-to-text algorithm is rather poor. Because only a small amount of keywords need to be saved for it to be useful, it is not really a problem if the voice-to-text algorithm recognizes 50% of the words or even less.

Optionally or additionally to the process described above, the user could be offered to see the list of words as they are created during the call and potentially even edit or use the words during the voice call e.g. copy selected words into a new text message.

FIG. 6 shows a screen displaying previous calls with keywords found according to the process described in conjunction with FIG. 5. This is shown on a display such as the display 203 of FIG. 2.

A screen 640 shows two previously voice call records 641, 645 originated from the local mobile terminal 100. Looking in more detail of one of the records 641, the name 644 (as stored in the list of contacts) of the remote party of the conversation is shown on the first row. On the second row, the date and time 642 of the voice call is shown. Finally the keywords 643 extracted from the voice call is shown. The keywords 643 are here shown on two rows, but these could equally well be shown on one row or three or more rows. Additionally, if necessary, the keywords can scroll horizontally or vertically through the available space.

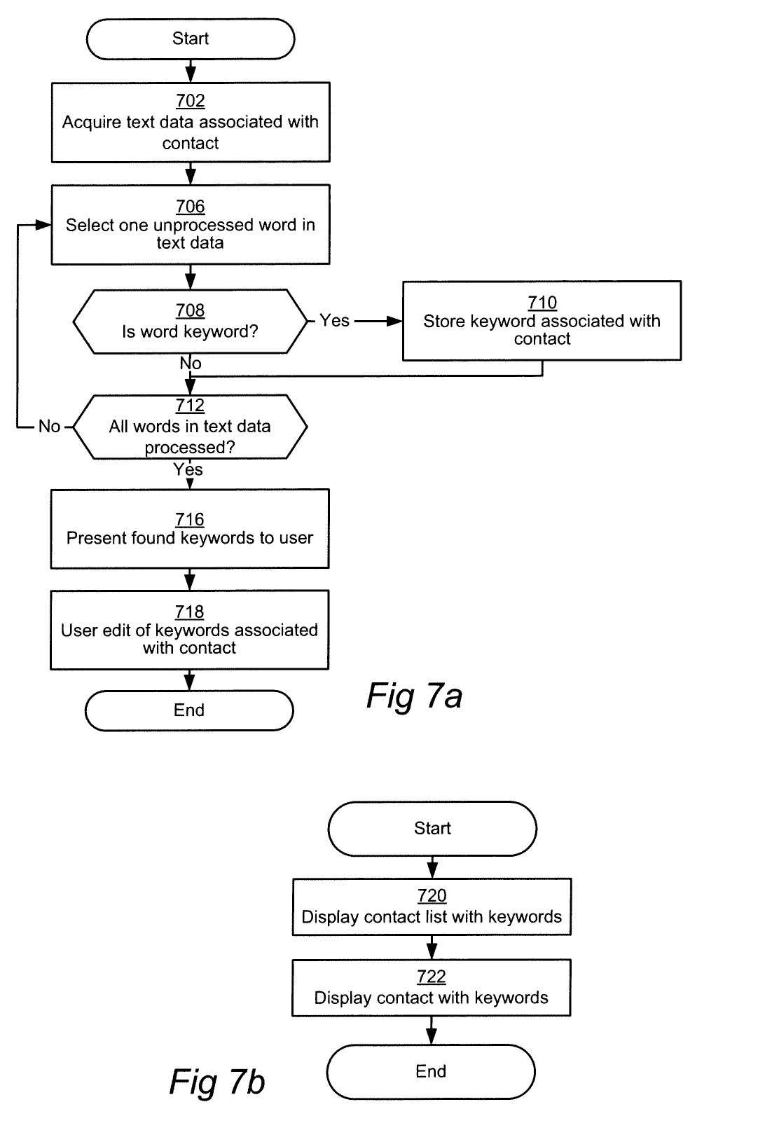

FIG. 7a is a flowchart diagram illustrating the execution of the mobile terminal 200 shown in FIG. 2 to store keywords for a contact record. Optionally, this processing can be made user configurable, such that it will not be performed if the user has indicated it should not. The trigger to start this process can be a sent or received text message, multimedia message etc. or a start of a voice communication.

In an acquire text data associated with contact step 702, text data associated with contact is acquired. This can for example be text data from a text message, text data from a multimedia message, text data from an instant messaging conversation, audio data from a voice call converted to text data using speech-to-text algorithms (like discussed above), etc. In other words, the text data can be any text data derived from communication with a contact.

In a select one unprocessed word in text data step 706, one of the words in the acquired text data is selected for processing.

In the conditional is word keyword step 708, it is determined if the word being processed, or candidate word, is a keyword. There are several ways that this can be done which will now be explained.

One way to determine a keyword is to check the word length of the candidate word. If the number of letters exceeds a certain number, the candidate word is considered to be a keyword. This will exclude most common words which are less unique and therefore less descriptive.

Another way to determine a keyword is to check if the candidate word is in a list of words which are considered less common and therefore are good keywords. Thus, if there is a match between the candidate word and a word in the list of less common words, the candidate word is considered a keyword. Optionally, the list of less common words is user configurable.

Yet another way to determine a keyword is to check if the candidate word is not in a list of words which are considered common. The candidate word is thus likely to be less common and therefore more unique if it is not in the list of common words. Such a list of common words can for example be a list of words used for predictive text entry, such as T9. Optionally, the user can edit this list of common words.

Additionally, in one embodiment, the candidate word can be checked against a list of keywords determined previously, where the candidate word is not considered a keyword if it has been determined to be a keyword previously, either as a keyword associated with the contact now in question, or all previous keywords.

If the candidate word is considered a keyword, the process proceeds to a store keyword associated with contact step 710. If, on the other hand, the word is not determined to be a keyword, the process proceeds to a conditional all words in text data processed step 712.

In the store keyword step 710, the keyword is stored, associated with the contact in question. The keyword may be stored directly in persistent memory or it may be stored in volatile memory initially, for later storage in persistent memory.

In the conditional all words in text data processed step 712, it is determined if all the words in the text data has been processed. If this is the case, the process proceeds to a present found keywords to user step 716. If, on the other hand, there are more words to be processed, the process returns to the select one unprocessed word in text data step 706.

In the present found keywords to user step 716, the user is presented with all keywords that have been found in the acquired text data.

In the user edit of keywords step 718, the user can edit the keywords that are presented. The user can add, remove and edit keywords, before accepting the list. When the list is accepted, the keywords are stored in persistent memory, associated with the contact in question and this process ends.

Optionally, the keyword list for each contact is limited to a certain number of keywords, where oldest words are removed as new words are added. In other the list would work according to a first-in-first-out order.

FIG. 7b is a flowchart diagram illustrating the execution of the mobile terminal shown in FIG. 2 to view keywords for a contact.

In a display contact list with keywords step 720, when the user wishes to view the contact list in the mobile terminal, the list is presented with keywords shown for each contact. The keywords can be shown on a separate row under each current contact. If all the keywords do not fit on one row, either the list is truncated by the edge of the display, or several rows are used. If truncation is used, a highlighted contact can let the keywords scroll horizontally allowing the user to view all the keywords over time.

In a display contact with key words step 722, details about the contact is shown, including key words.

A search functionality can also be provided, allowing the user to search all the keywords for contacts for easier contact navigation.

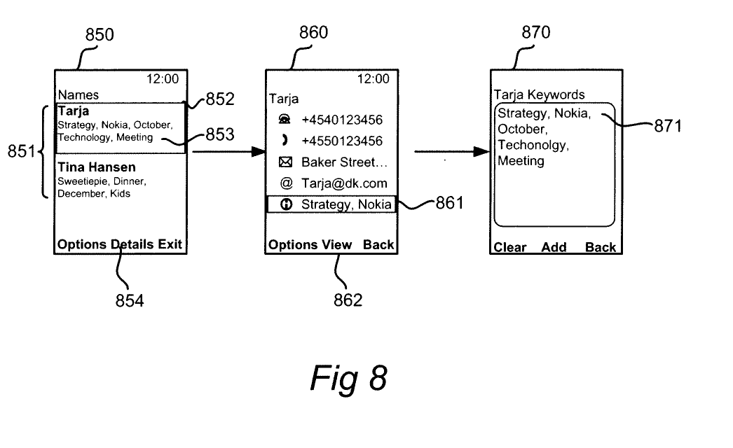

FIG. 8 shows a view of three screens illustrating the process described in conjunction with FIG. 7b, e.g. shown on display 203 of FIG. 2.

A first screen 850 shows a screen of two contacts 851, where one contact 852 is selected. The selected contact 852 shows keywords 853 on two rows, but one row could also be used. Optionally, the keywords can scroll automatically for the selected contact 852. If the user presses a key associated with contact details 854, e.g. the middle soft key, the mobile terminal switches to a contact details screen 860.

In the contact details screen 860, the contact details known in the art are shown. Additionally the keywords 861 associated with the contact are shown. If the keywords are selected (e.g. using joystick 211 of FIG. 2) and the user presses a key associated with viewing details 862, the mobile terminal switches to a keyword details screen 870,

In the keyword details screen 870, the keywords 871 are displayed in the main part of the screen. The user is provided with options to add, delete or edit the keywords.

For privacy reasons, the keyword functionality can be password protected. Additionally, the contact list can be configured not to display keywords.

Optionally, as an additional effect, the phone could have a pre-stored list of keywords which are mapped to certain colors which then are mapped to the contacts who have the specific keywords in their keywords field. E.g. the phone knows the word “honey” and if that word is included in a contact's keyword list, the contact name could be colored red to indicate affection.

While the term voice call has been used above, the disclosed embodiments is not limited to only voice calls. When the term voice call or voice communication is used, it is to be interpreted as communication including voice or audio communication. In other words, multimedia communication, including combined video and audio communication works equally well within the scope of the disclosed embodiments.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for recording audio using a mobile communication terminal while a microphone connected to said mobile communication terminal provides audio data for an audio communication channel to a remote party, said method comprising:
detecting a first user input indicating a private recording is to be started;
stopping provision of audio data from said microphone to said audio communication channel;
receiving an audio signal from said microphone; and
recording said audio signal.

2. The method according to claim 1, further comprising:
detecting a second user input indicating said private recording is to be paused;
pausing said recording of said audio signal; and
reestablishing said provision of audio data from said microphone to said audio communication channel.

3. The method according to claim 2, wherein said detecting a first user input involves detecting a first actuation of a user interface element and said detecting a second user input involves detecting a second actuation of said user interface element.

4. The method according to claim 2, wherein said detecting a first user input involves detecting a depression of a user interface element and said detecting a second user input involves detecting a release of said user interface element.

5. The method according to claim 1, further comprising:
detecting a third user input indicating said private recording is to be stopped;
stopping said recording of said audio signal; and
storing said recording of said audio signal in persistent memory.

6. A mobile communication terminal for recording audio while a microphone connected to said mobile communication terminal provides audio data for an audio communication channel to a remote party, said mobile communication terminal comprising a controller, wherein:
said controller is configured to detect a first user input indicating a private recording is to be started;
said controller is further configured to, as a response to said first user input, stop said provision of audio data from said microphone to said audio communication channel;
said controller is further configured to receive an audio signal from a microphone; and
said controller is further configured to, as a second response to said first user input, record said audio signal.

7. A computer program product comprising software instructions that, when executed in a mobile communication terminal, performs the method according to claim 1.

8. A method for storing keywords using a mobile communication terminal while a user of said mobile communication terminal is in audio communication over a communication channel with a remote party, said method comprising:
acquiring audio data related to said communication channel converting at least part of said audio data to text data;
determining if said text data contains a keyword;
if it is determined that said text data contains a keyword, storing said keyword associated with information regarding said remote party.

9. The method according to claim 8, wherein said determining if said text data contains a keyword involves comparing a candidate word of said text data against a list of words, said candidate word being determined to be a keyword if said candidate word is excluded in said list.

10. The method according to claim 9, wherein said list of words is a list of words used for predictive text functionality used when entering text in said mobile communication terminal.

11. The method according to claim 8, wherein said determining if said text data contains a keyword involves comparing a candidate word of said text data against a list of words, said candidate word being determined to be a keyword if said candidate word is included in said list.

12. The method according to claim 8, wherein said determining if said text data contains a keyword involves counting the number of letters of a candidate word of said text data, said candidate word being determined to be a keyword if said number of letters is greater than a threshold number of letters.

13. The method according to claim 8, wherein said storing said keyword involves storing said keyword, said keyword being associated with a contact record of said mobile communication terminal related to said remote party.

14. The method according to claim 8, further comprising, before said storing said keyword:
if it is determined that said text data contains a keyword, displaying said keyword to said user.

15. The method according to claim 14, further comprising, before said storing said keyword:
if it is determined that said text data contains a keyword, allowing said user to edit said keyword.

16. The method according to claim 8, wherein said converting audio data, determining if said text data contains a keyword, and if it is determined that said text data contains a keyword, storing said keyword, are repeated until said audio communication ends.

17. The method according to claim 16, further comprising, after said audio communication ends:
displaying all keywords determined during said audio communication.

18. The method according to claim 17, further comprising, after said displaying all keywords:
enabling removal any of said displayed keywords.

19. The method according to claim 17, further comprising, after said displaying all keywords:
enabling addition of user entered keywords to said displayed keywords.

20. A mobile communication terminal for storing keywords using a mobile communication terminal while a user of said mobile communication terminal is in audio communication over a communication channel with a remote party, said mobile communication terminal comprising a controller and memory, wherein:
said controller is configured to acquire audio data related to said communication channel;
said controller is configured to convert at least part of said audio data to text data;
said controller is configured to determine if said text data contains a keyword;
said controller is configured to, if it is determined that said text data contains a keyword, store said keyword in said memory, associated with information regarding said remote party.

21. A computer program product comprising software instructions that, when executed in a mobile communication terminal, performs the method according to claim 8.

22. A method for managing contact data in a mobile communication terminal, where keywords are associated with a contact record stored by said mobile communication terminal, said method comprising:
acquiring a keyword from text data related to communication with a party identified by said contact record;
storing said keyword with an association to said contact record.

23. The method according to claim 22, wherein said acquiring a keyword involves acquiring a keyword from text data in a text message communication with a party identified by said contact record.

24. The method according to claim 22, wherein said acquiring a keyword involves acquiring a keyword from text data in a instant messaging communication with a party identified by said contact record.

25. The method according to claim 22, wherein said acquiring a keyword involves converting at least part of audio data from voice communication with a party identified by said contact record to text data and acquiring a keyword from said text data.

26. The method according to claim 22, further comprising:
when displaying a contact record, displaying at least part of keywords stored and associated with said contact record.

27. The method according to claim 22, further comprising:
when displaying a list of contact records, displaying at least part of keywords stored and associated with each displayed contact record.

28. The method according to claim 27, wherein said displaying a list of contact records involves:
when displaying a list of contact records, displaying at least part of keywords stored and associated with each contact record, and for a highlighted contact record, scrolling through all keywords stored and associated with said highlighted contact record on one row.

29. The method according to claim 22, wherein said acquiring a keyword from text data involves comparing a candidate word of said text data against a list of words, said candidate word being determined to be a keyword if said candidate word is excluded in said list.

30. The method according to claim 29, wherein said list of words is a list of words used for predictive text functionality used when entering text in said mobile communication terminal.

31. The method according to claim 22, wherein said acquiring a keyword from text data involves comparing a candidate word of said text data against a list of words, said candidate word being determined to be a keyword if said candidate word is included in said list.

32. The method according to claim 22, wherein said acquiring a keyword from text data involves counting the number of letters of a candidate word of said text data, said candidate word being determined to be a keyword if said number of letters is greater than a threshold number of letters.

33. A mobile communication terminal for managing contact data, where keywords are associated with a contact record stored by said mobile communication terminal, said mobile communication terminal comprising a controller and memory, wherein:
said controller is configured to acquire a keyword from text data related to communication with a party identified by said contact record;
said controller is configured to store said keyword with an association to said contact record.

34. A computer program product comprising software instructions that, when executed in a mobile communication terminal, performs the method according to claim 22.
